(19) United States
(12) Patent Application Publication
(10) Pub. No.: US 2016/0318128 A1
(43) Pub. Date: Nov. 3, 2016

(54) Metal Printer

(71) Applicant: Brigante Aviation Limited, BLACKPOOL (GB)

(72) Inventor: Michael Joseph Dutton, BLACKPOOL (GB)

(21) Appl. No.: 15/139,464

(22) Filed: Apr. 27, 2016

(30) Foreign Application Priority Data
Apr. 28, 2015 (GB) 1507177.2

(51) Int. Cl. B23K 26/342; B23K 26/0622; B23K 26/144

(52) U.S. Cl. CPC B23K 26/342; B23K 26/144; B23K 26/0622

(57) ABSTRACT

A 3 dimensional, 3D, printer assembly for in use printing a 3D component from a filler material, the 3D printer assembly comprising: a 3D printer head arranged to in use deliver the filler material; a laser head for a laser arranged to in use deliver a laser pulse to the filler material; and a controller arranged to control the printer head and the laser head to in use print the 3D component.

### FIELD OF THE INVENTION

The present invention relates to 3D printer assemblies, and to related methods of use of 3D printer assemblies, particularly for use in pulsed-laser 3D printing of metals.

### BACKGROUND TO THE INVENTION

Engineered components for machinery are typically manufactured by machining or fabricating metal stock, castings or sintered parts. However, these manufacturing methods are typically multi-step or require significant tooling and thus are generally neither amenable nor economic for low-volume manufacturing, such as for prototype or custom components.

Laser sintering of metallic powders has been developed as an alternative manufacturing method for such components. However, the rate, scale, resolution, cost, complexity and material options may limit the application of this laser sintering technique.

Example embodiments of the present invention aim to address at least one of the issues identified above, or related issues.

### SUMMARY OF THE INVENTION

According to an aspect of the invention, there is provided a 3 dimensional, 3D, printer assembly for in use printing a 3D component from a filler material, the 3D printer assembly comprising:

a 3D printer head arranged to in use deliver the filler material;

a laser head for a laser arranged to in use deliver a laser pulse to the filler material; and

a controller arranged to control the printer head and the laser head to in use print the 3D component.

Herein, a substrate may comprise an item on which a filler material may be deposited. That is, the filler material may be deposited directly onto the substrate so as to print the 3D component using the 3D printer on the substrate, in which the 3D component does not comprise the substrate i.e. the 3D component may be uncoupled from the substrate. For example, the substrate may be a flat machine bed, a plate or a surface table, in which the substrate may comprise a metal e.g. stainless steel, cast iron or a ceramic e.g. alumina, glass. Additionally, the substrate may comprise a temporary substrate in which the filler material may be deposited onto the temporary substrate such that the 3D component comprising, for example, a cantilever, a void may be printed using the 3D printer assembly and the temporary substrate uncoupled form the 3D component. Alternatively, the 3D component printed using the 3D printer assembly may comprise the substrate. That is, the filler material may be deposited directly onto a substrate so as to print the 3D component using the 3D printer on the substrate, in which the substrate integrates into the 3D component i.e. the 3D component is coupled to the substrate. For example, the substrate may be another component, a part-finished component or the part-printed 3D component i.e. previously-deposited filler material.

In an example embodiment, the 3D printer head is arranged to be repositioned in use. In this way, the 3D printer head may be arranged at, for example, a distance from and/or an angle to a substrate. In this way, the 3D printer head may be arranged at, for example, an optimum and/or a predetermined distance from and/or an optimum and/or predetermined to a substrate. In this way, the 3D printer head may be arranged to deliver a filler material to, for example, a position on a substrate, a plurality of positions on a substrate. For example, the 3D printer head may translate in one, two or three orthogonal dimensions and/or rotate about one, two or three orthogonal axes. In this way, a 3D component may be printed by the 3D printer assembly by depositing a filler material at a plurality of positions in three dimensions. Additionally and/or alternatively, a substrate may be repositioned in use. For example, a moving bed may be repositioned in use, in which the moving bed may translate in one, two or three orthogonal dimensions and/or rotate about one, two or three orthogonal axes.

In an example embodiment, the laser head is arranged to be repositioned in use. In this way, the laser head may be arranged, for example, a distance from and/or an angle to a filler material and/or a substrate. In this way, the laser head may be arranged at, for example, an optimum and/or a predetermined distance from and/or an optimum and/or predetermined to a filler material and/or a substrate. In this way, the laser head may be arranged to deliver a laser pulse to, for example, a position on a filler material delivered by the 3D printer head and/or a substrate, a plurality of positions on a filler material delivered by the 3D printer head and/or a substrate. For example, the laser head may translate in one, two or three orthogonal dimensions and/or rotate about one, two or three orthogonal axes. In this way, a position and/or orientation of the laser head may be optimised to deliver a laser pulse to a filler material and/or substrate e.g. a laser pulse shape may be maintained while printing a 3D component. In contrast, a fixed laser head in which a position and/or orientation of the fixed laser head are/is fixed will compromise delivery of a laser pulse to a filler material, since a laser pulse shape, for example, will change while printing a 3D component.

In an example embodiment, the 3D printer head and the laser head are arranged to be repositioned in use. In this way, a filler material may be printed or deposited by the 3D printer assembly at a position and/or a plurality of positions on for example a substrate.

In an example embodiment, the controller is arranged to control a position and/or an angle and/or an orientation and/or a speed of movement of the 3D printer head. In this way, the controller may control the position and/or the angle and/or the orientation and/or the speed of movement of the 3D printer head to deliver the filler material to, for example, a position on a substrate, a plurality of positions on the substrate according to, for example, a design of a 3D component to be printed by the 3D printer assembly. In this way, the controller may control the position and/or the angle and/or the orientation and/or the speed of movement of the 3D printer head to deliver the filler material to, for example, the position on the substrate, the plurality of positions on the substrate according to, for example, the design of the item to be printed by the 3D printer assembly, while controlling, for example maintaining, optimising a position from and/or angle to a substrate and/or a rate of deposition of the filler material.

In an example embodiment, the controller is arranged to control a position and/or angle and/or an orientation and/or a speed of movement of the laser head. In this way, the controller may control the position and/or the angle and/or the orientation and/or the speed of movement of the laser head to deliver a laser pulse to, for example, a position on the filler material delivered by the 3D printer head and/or to the substrate, a plurality of positions on the filler material delivered by the 3D printer head and/or to the substrate according to, for example, a design of the 3D component to be printed by the 3D printer assembly. In this way, the controller may control the position and/or the angle and/or the orientation and/or the speed of movement of the laser head to deliver a laser pulse to, for example, the position on the filler material delivered by the 3D printer head and/or to the substrate, the plurality of positions on a filler material delivered by the 3D printer head and/or to the substrate according to, for example, the design of the 3D component to be printed by the 3D printer assembly while controlling, for example maintaining, optimising a position from and/or angle to the filler material delivered by the 3D printer and/or to the substrate and/or a rate of deposition of the filler material.

In an example embodiment, the controller is arranged to control the position and/or the angle and/or the orientation and/or the speed of movement of the 3D printer head and to control the position and/or the angle and/or the orientation and/or the speed of movement of the laser head. In this way, the controller may control the position and/or the angle and/or the orientation and/or the speed of movement of the laser head relative to the position and/or the angle and/or the orientation and/or the speed of movement of the filler material delivered by the 3D printer head and/or to the substrate, while controlling a the position and/or the angle and/or the orientation and/or the speed of movement of the 3D printer head according to for example, the design of the 3D component to be printed by the 3D printer assembly.

In an example embodiment, the printer head and the laser head are coupled. In this way, an arrangement, for example a relative arrangement, of the printer head and the laser head may be pre-determined and/or configured in use. In an example embodiment, the printer head and the laser head are coupled in a variably-spaced relationship. In an example embodiment, the printer head and the laser head are coupled in a fixed-space relationship.

In an example embodiment, the laser head is arranged to deliver a laser pulse to a filler material delivered by the 3D printer head. In an example embodiment, the laser head is arranged to deliver a laser pulse to a filler material delivered by the 3D printer head proximal an end of the filler material. In an example embodiment, the laser head is arranged to deliver a laser pulse to a filler material delivered by the 3D printer head proximal an exposed end of the filler material.

In an example embodiment, the laser head is arranged to deliver a laser pulse to heat an amount of a filler material delivered by the 3D printer head. In an example embodiment, the laser head is arranged to heat an amount of a filler material delivered by the 3D printer head proximal an end of the filler material. In an example embodiment, the laser head is arranged to heat an amount of a filler material delivered by the 3D printer head proximal an exposed end of the filler material. In an example embodiment, the laser head is arranged to melt an amount of a filler material delivered by the 3D printer head. In an example embodiment, the laser head is arranged to melt an amount of a filler material delivered by the 3D printer head, wherein the amount of the filler material comprises a volume of 3.68×10⁻⁹ m³, less than 3.68×10⁻⁹ m³, more than 3.68×10⁻⁹ m³. In an example embodiment, the laser head is arranged to deliver a laser pulse wherein the laser pulse comprises a laser pulse length one selected from a group comprising: a range 1×10⁻³-100×10⁻³ s, a range 5×10⁻³-10×10⁻³ s, 5×10⁻³ s, 7.5×10⁻³ s and 10×10⁻³ s. In an example embodiment, the laser head is arranged to deliver a laser pulse wherein the laser pulse comprises a laser pulse energy one selected from a group comprising: a range 1-100 J, a range 10-20 J, 10 J, 15 J and 20 J. In an example embodiment, the laser head is arranged to deliver a plurality of laser pulses. In an example embodiment, the laser head is arranged to deliver a plurality of laser pulses, wherein a frequency of the plurality of laser pulses is one selected from a group comprising: a range 1-100 Hz, a range 15-22 Hz, 15 Hz, 18.5 Hz and 22 Hz.

In an example embodiment, the 3D printer assembly is arranged to deliver a second laser pulse to a substrate. In an example embodiment, the 3D printer assembly is arranged to deliver a second laser pulse to the 3D component. In an example embodiment, the laser head is arranged to deliver a second laser pulse to a substrate. In an example embodiment, the laser head is arranged to deliver a second laser pulse to the 3D component. In an example embodiment, the laser head is arranged to deliver a second laser pulse to a substrate proximal the filler material. In an example embodiment, the laser head is arranged to deliver a second laser pulse to a substrate proximal an end of the filler material. In an example embodiment, the laser head is arranged to deliver a second laser pulse to heat an amount of a substrate. In an example embodiment, the laser head is arranged to deliver a second laser pulse to heat an amount of a substrate proximal the filler material. In an example embodiment, the laser head is arranged to deliver a second laser pulse to heat an amount of a substrate proximal an end of the filler material. In an example embodiment, the laser head is arranged to deliver a second laser pulse to melt an amount of a substrate. In an example embodiment, the laser head is arranged to deliver a second laser pulse to melt an amount of a substrate proximal the filler material. In an example embodiment, the laser head is arranged to deliver a second laser pulse to melt an amount of a substrate proximal an end of the filler material. In an example embodiment, the laser head is arranged to deliver a second laser pulse wherein a second laser pulse length may be equal to, more than or less than a first laser pulse length. In an example embodiment, the laser head is arranged to deliver a second laser pulse wherein a second laser pulse energy may be equal to, more than or less than a first laser pulse energy. In an example embodiment, the laser head is arranged to deliver a plurality of second laser pulses. In an example embodiment, the laser head is arranged to deliver a plurality of laser pulses, wherein a frequency of the plurality of second laser pulses may be equal to, more than or less than a frequency of a plurality of laser pulses. In an example embodiment, the laser head is arranged to deliver a laser pulse and a second laser pulse successively. In an example embodiment, the laser head is arranged to deliver a repeat sequence of laser pulses and second laser pulses, wherein the laser pulses and second laser pulses may be delivered alternately (i.e. a laser pulse followed by a second laser pulse at a 1:1 repeat sequence) or at another repeat sequence e.g. 10:1, 5:1, 2:1, 1:2, 1:5, 1:10.

In an example embodiment, the controller is arranged to control the laser head to deliver a laser pulse. In an example embodiment, the controller is arranged to control the laser head to deliver a second laser pulse. In an example embodiment, the controller is arranged to control the laser head to deliver a laser pulse and a second laser pulse. In an example embodiment, the controller is arranged to modify one selected from a group comprising: a laser pulse length, a laser pulse energy, a laser pulse frequency, a second laser pulse length, a second laser pulse energy or a second laser pulse frequency. In an example embodiment, the controller is arranged to modify in use while a 3D component is being printed by the 3D printer assembly one selected from a group comprising: a laser pulse length, a laser pulse energy, a laser pulse frequency, a second laser pulse length, a second laser pulse energy and a second laser pulse frequency. In this way, the controller may control the laser pulses delivered by the laser head during printing of the 3D component. For example, a laser pulse energy and/or a second laser pulse energy may be decreased from an initial value as a temperature of the filler material and/or the substrate increases, respectively, in which the temperature of the filler material and/or substrate may be communicated to the controller from, for example, an infrared thermometer directed towards the 3D printer head and/or the substrate and/or a thermocouple coupled to the 3D printer head and/or substrate. For example, a laser pulse frequency or a second laser pulse frequency or a laser pulse repeat sequence may be increased in use from an initial value as a rate of deposition of the filler material is increased.

In an example embodiment, the 3D printer head is arranged to deliver a filler material, wherein the filler material comprises one selected from a group comprising: a metal, a ferrous alloy, a non-ferrous alloy, an aluminium alloy, a 6XXX series aluminium alloy, a 5XXX series aluminium alloy, a flux and a polymer. In this way, for example, a 6XXX series aluminium alloy 3D component may be printed by the 3D printer assembly. Optionally, a flux may be delivered with a metal, so as to improve and/or optimise a deposited metallurgy of the metal. Optionally, a polymer may be printed by the 3D printer assembly e.g. a polymeric temporary support for a 3D component may be printed.

In an example embodiment, the 3D printer head is arranged to deliver the filler material, wherein the filler material comprises one selected from a group comprising: a wire, a cored wire and a coated wire. In this way, a continuous filler material from e.g. a spool may be delivered by the 3D printer head.

In an example embodiment, the 3D printer head is arranged to deliver the filler material, wherein the filler material comprises a wire having a diameter in the range 0.8 mm to 1.6 mm or having a diameter in the range 0.8 mm to 2.0 mm or having a diameter of 1.75 mm or having a diameter less than 0.8 mm or having a diameter greater than 1.6 mm. In this way, readily-available welding filler materials may be delivered by the 3D printer head.

In an example embodiment, the 3D printer head is arranged to deliver the filler material to a substrate. In an example embodiment, the controller is arranged to control the 3D printer head to deliver the filler material to a substrate. In this way, for example, the filler material may be delivered at a controlled rate to a position on the substrate by the controller.

In an example embodiment, the 3D printer assembly is arranged to deliver a temporary substrate material to print a temporary substrate on and/or around which the 3D component may be printed by the 3D printer assembly, as described above. In an example embodiment, the 3D printer head is arranged to deliver a temporary substrate material to print a temporary substrate on and/or around which the 3D component may be printed by the 3D printer assembly, as described above. In an example embodiment, the 3D printer head is arranged to deliver a filler material and a temporary substrate material. For example, the 3D printer head may successively or simultaneously deliver a filler material and a temporary substrate material. In an example embodiment, the controller is arranged to control the 3D printer head to deliver a temporary substrate material.

In an example embodiment, the 3D printer head is arranged to deliver a temporary substrate material, wherein the temporary substrate material comprises one selected from a group comprising: a metal, a non-ferrous alloy, an aluminium alloy, a polymer and a thermoplastic. In this way, a 3D temporary substrate may be printed by the 3D printer assembly, upon or around which a 3D component may be printed by the 3D printer assembly. For example, the 3D temporary substrate may be subsequently removed from the 3D component by physical means (e.g. melting, abrading, jet washing) and/or chemical means (e.g. dissolution, reaction).

In an example embodiment, the 3D printer head is arranged to deliver the temporary substrate material, wherein the temporary substrate material comprises one selected from a group comprising: a wire, a cored wire, a coated wire and a powder.

In an example embodiment, the 3D printer head is arranged to deliver the temporary substrate material, wherein the temporary substrate material comprises a wire having a diameter in the range 0.8 mm to 1.6 mm or having a diameter in the range 0.8 mm to 2.0 mm or having a diameter of 1.75 mm or having a diameter less than 0.8 mm or having a diameter greater than 1.6 mm.

In an example embodiment, the 3D printer head is arranged to deliver the temporary substrate material to a substrate. In an example embodiment, the controller is arranged to control the 3D printer head to deliver the temporary substrate material. In this way, the 3D printer assembly may be controlled to deposit a 3D temporary substrate in a position or a plurality of positions relative to a printed 3D component.

In an example embodiment, the 3D printer assembly comprises a gas outlet. In an example embodiment, the 3D printer assembly comprises a gas outlet arranged to deliver a gas. In an example embodiment, the 3D printer assembly comprises a gas outlet arranged to deliver a gas, wherein the gas comprises one selected from a group comprising: a shield gas, a reactive gas, carbon dioxide, an inert gas and argon. In this way, for example, reaction or oxidation of a filler material delivered by the 3D printer assembly and/or a substrate on or in which the filler material is printed or deposited may be controlled and/or reduced and/or minimized during heating and/or melting by a laser pulse delivered by 3D printer assembly.

In an example embodiment, the 3D printer assembly comprises a chamber arranged to comprise a gas, wherein the gas comprises one selected from a group comprising: a shield gas, a reactive gas, carbon dioxide, an inert gas and argon. In an example embodiment, the 3D printer assembly comprises a chamber, the chamber encloses one selected from a group comprising: the 3D printer head, the laser head and a substrate in use, the chamber arranged to comprise a gas, as described above. In an example embodiment, the 3D printer assembly comprises a chamber, the chamber enclosing the 3D printer head, the laser head and a substrate in use, the chamber arranged to comprise a gas, as described above. In an example embodiment, the 3D printer assembly comprises a chamber arranged to enclose the 3D printer head and the laser head, wherein the chamber is arranged to comprise the gas. In this way, a filler material may be printed or deposited by the 3D printer assembly while reaction or oxidation of the filler material delivered by the 3D printer assembly and/or a substrate on or in which the filler material is printed or deposited may be controlled and/or reduced and/or minimized during heating and/or melting by a laser pulse delivered by 3D printer assembly. For example, the 3D printer assembly may comprise an enclosure that isolates the 3D printer assembly from an external environment, in which the enclosure comprises a shielding gas, thereby controlling gaseous conditions of deposition of the filler material.

In an example embodiment, the 3D printer head comprises a gas outlet. In an example embodiment, the 3D printer head comprises a gas outlet arranged to deliver a gas. In an example embodiment, the 3D printer head comprises a gas outlet arranged to deliver a gas, wherein the gas comprises one selected from a group comprising: a shield gas, a reactive gas, carbon dioxide, an inert gas and argon. In an example embodiment, the 3D printer head comprises a gas outlet arranged to deliver a gas proximal a filler material delivered by the 3D printer head, for example, around a filler material, around a filler material proximal a position to which a laser pulse is delivered by the laser head, around an end of a filler material proximal a substrate, toward a filler material and/or substrate heated by a laser pulse delivered by the laser head. In an example embodiment, the 3D printer head comprises a plurality of such gas outlets. In an example, the 3D printer head comprises a plurality of such gas outlets arranged proximal and/or around a filler material outlet from which the filler material is delivered by the 3D printer head. In this way, for example, reaction or oxidation of a filler material delivered by the 3D printer head and/or a substrate on or in which a filler material is printed or deposited may be controlled and/or reduced and/or minimized during heating and/or melting by a laser pulse delivered by the laser head.

In an example embodiment, the laser head comprises a gas outlet. In an example embodiment, the laser head comprises a gas outlet arranged to deliver a gas. In an example embodiment, the laser head comprises a gas outlet arranged to deliver a gas, wherein the gas comprises one selected from a group comprising: a shield gas, a reactive gas, carbon dioxide, an inert gas and argon. In an example embodiment, the laser head comprises a gas outlet arranged to deliver a gas proximal a position to which a laser pulse is delivered by the laser head. In an example embodiment, the laser head comprises a gas outlet arranged to deliver a gas to a laser pulse guide through which a laser pulse is delivered by the laser head. In this way, for example, the laser head may be shielded or curtained from a gas and/or sputter of a filler material delivered by the 3D printer head and/or a substrate on or in which a filler material is printed or deposited during heating and/or melting by a laser pulse delivered by the laser head. In this way, filler material vapour and/or sputter are isolated from for example a window of the laser head through which a laser pulse is delivered. In this way, a cleanliness and/or transparency of the window is maintained or degradation minimized, thereby reducing maintenance requirements.

In an example embodiment, the controller is arranged to control a gas delivered by the 3D printer assembly. In an example embodiment, the controller is arranged to control one of selected from a group comprising a flow, a pressure and composition of a gas delivered by the 3D printer assembly. In an example embodiment, the controller is arranged to control a plurality of gases delivered by the 3D printer assembly. In an example embodiment, the controller is arranged to control one of selected from a group comprising a flow, a pressure and composition of a plurality of gases delivered by the 3D printer assembly. In an example embodiment, the controller is arranged to control a gas delivered from a gas outlet of one selected from a group comprising: the 3D printer assembly, the 3D printer head, the laser head. In an example embodiment, the 3D printer assembly comprises a gas device comprising one selected from a group comprising: a valve, a valve manifold, a flow controller and a mass flow controller (MFC) and the controller is arranged to control the gas device.

In an example embodiment, the 3D printer head comprises a 3D printer tip. In an example embodiment, the 3D printer head comprises a 3D printer tip, wherein the 3D printer tip comprises a passageway through which a filler material is delivered by the 3D printer head. In an example embodiment, an end of a 3D printer tip is arrangeable proximal a substrate on or in which a filler material is printed or deposited by the 3D printer assembly. In an example embodiment, an end of a passageway in a 3D printer tip through which a filler material is delivered by the 3D printer head is arrangeable proximal a substrate on or in which a filler material is printed or deposited by the 3D printer assembly. In an example embodiment, a 3D printer tip comprises one selected from a group comprising: a refractory material, a ceramic, a refractory alloy, a nickel-chromium based alloy, an Inconel alloy, Inconel 625 and Inconel 718. In this way, a 3D printer tip may resist effects due to or resulting from heat transferred to a 3D printer tip from a laser pulse delivered by the laser head, for example degradation, oxidation or deformation of the 3D printer tip. In an example embodiment, a 3D printer tip comprises a cooling fin. In an example embodiment, a 3D printer tip comprises a plurality of cooling fins. In this way, heat transferred to a 3D printer tip from a laser pulse delivered by the laser head may be dissipated. In an example embodiment, a 3D printer tip comprises a gas outlet arranged to deliver a gas, wherein the gas comprises one selected from a group comprising: a shield gas, a reactive gas, carbon dioxide, an inert gas and argon. In this way, a gas may be delivered through a 3D printer tip towards a filler material delivered by the 3D printer head and/or a substrate proximal a position to which a laser pulse is delivered by the laser head, thereby providing a gas cooling to the 3D printer tip and/or gas heating to the filler material and/or substrate and/or control and/or reduce and/or minimize a reaction or oxidation of the filler material and/or substrate.

In an example embodiment, the 3D printer head comprises a laser pulse aperture. In an example embodiment, the 3D printer head comprises a laser pulse aperture through which a laser pulse delivered by the laser head is delivered to a filler material delivered by the 3D printer head. In an example embodiment, the 3D printer head comprises a 3D printer tip wherein the 3D printer tip comprises a laser pulse aperture through which a laser pulse delivered by the laser head is delivered to a filler material delivered by the 3D printer head through the 3D printer tip.

In an example embodiment, the 3D printer assembly comprises a laser pulse guide. In an example embodiment, the laser head comprises a laser pulse guide. In an example embodiment, the laser head comprises a laser pulse guide through which a laser pulse is delivered by the laser head. In an example embodiment, the laser head comprises a laser pulse guide, wherein the laser pulse guide comprises a laser pulse outlet, through which a laser pulse is delivered by the laser head, proximal a filler material delivered by the 3D printer head. In an example embodiment, the laser head comprises a laser pulse guide through which a laser pulse is delivered by the laser head, in which the laser pulse guide comprises a gas, for example, a gas as described above. In an example embodiment, the laser head comprises a laser pulse guide through which a laser pulse is delivered by the laser head and the laser head comprises a gas outlet in fluid communication with the laser pulse guide, whereby in use the laser pulse guide comprises a gas arranged to isolate the laser head from the 3D printer head, for example, a shield gas as described previously is arranged to flow from the laser head towards the 3D printer head. In this way, for example, the laser head may be shielded or curtained from a gas and/or sputter of a filler material delivered by the 3D printer head and/or a substrate on or in which a filler material is printed or deposited during heating and/or melting by a laser pulse delivered by the laser head.

In an example embodiment, the 3D printer assembly comprises a laser shutter. In an example embodiment, the 3D printer assembly comprises a laser shutter arranged to be one of selected from a group comprising opened and closed. In an example embodiment, the 3D printer assembly comprises a laser shutter arrangeable to isolate the laser head from the 3D printer head. In an example embodiment, the laser head comprises a laser shutter. In an example embodiment, the laser head comprises a laser shutter arrangeable to isolate the laser head from the 3D printer head. In an example embodiment, the 3D printer head comprises a laser shutter. In an example embodiment, the 3D printer head comprises a laser shutter arrangeable to isolate the laser head from the 3D printer head. In an example embodiment, the 3D printer comprises a laser shutter arranged between the laser head and the 3D printer head. In an example embodiment, the 3D printer comprises a laser shutter arranged between the laser head and the 3D printer head, wherein the laser shutter is arrangeable to isolate the laser head from the 3D printer head. In an example embodiment, the 3D printer assembly comprises a laser pulse guide as described previously and the 3D printer assembly comprises a laser shutter arrangeable to one of selected from a group comprising open and close a laser pulse outlet of the laser pulse guide. In an example embodiment, the laser pulse guide comprises a laser shutter.

In an example embodiment, the controller is arranged to control a laser shutter. In an example embodiment, the controller is arranged to control a laser shutter, wherein the laser shutter is arrangeable to isolate the laser head from the 3D printer head. In an example embodiment, the controller is arranged to control a laser shutter, wherein the laser shutter is arrangeable to isolate the laser head from the 3D printer head, and wherein the controller is further arranged to control the laser shutter to open according to a timing of a laser pulse delivered by the laser head. In an example embodiment, the controller is arranged to control a laser shutter, wherein the laser shutter is arrangeable to isolate the laser head from the 3D printer head, and wherein the controller is further arranged to control the laser shutter to close according to a timing of a laser pulse delivered by the laser head. In this way, filler material vapour and/or sputter are isolated from for example a window of the laser head through which a laser pulse is delivered. In this way, a cleanliness and/or transparency of the window is maintained or degradation minimized, thereby reducing maintenance requirements.

In an example embodiment, the controller is arranged to control a temperature of a substrate. In an example embodiment, the controller is arranged to control heating of a substrate. In an example embodiment, the controller is arranged to control cooling of a substrate.

According to an aspect of the invention, there is provided a method of printing a 3 dimensional, 3D, component from a filler material using a 3D printer assembly, wherein the 3D printer assembly comprises:

a 3D printer head arranged to in use deliver the filler material;

a laser head for a laser arranged to in use deliver a laser pulse to the filler material; and

a controller arranged to control the printer head and the laser head to in use print the 3D component;

wherein the method comprises:

delivering the laser pulse to the filler material; and

delivering the filler material.

In an example embodiment, the method comprises delivering a second laser pulse to the 3D component.

In an example embodiment, the 3D printer assembly comprises a gas outlet and the method comprises delivering a gas. In an example embodiment, the method comprises delivering the gas to isolate the laser head from the 3D printer head by delivering the gas from the laser head towards the 3D printer head.

According to the present invention there is provided an apparatus and method as set forth in the appended claims. Other features of the invention will be apparent from the dependent claims, and the description which follows.

### BRIEF INTRODUCTION TO THE DRAWINGS

For a better understanding of the invention, and to show how embodiments of the same may be carried into effect, reference will now be made, by way of example, to the accompanying diagrammatic drawings in which:

FIG. 1 shows a schematic view of a 3D printer assembly according to an example embodiment;

FIG. 2 shows a schematic perspective view of a 3D printer head and a laser head for a 3D printer assembly according to an example embodiment;

FIG. 3 shows another schematic, partially-transparent perspective view of the 3D printer head and the laser head of FIG. 2;

FIG. 4 shows a schematic front elevation view of the 3D printer head and the laser head of FIG. 2;

FIG. 5 shows a schematic perspective view of the 3D printer head of FIG. 3;

FIG. 6 shows a schematic front elevation view of the 3D printer head of FIG. 5;

FIG. 7 shows a schematic bottom elevation view of the 3D printer head of FIG. 5;

FIG. 8 shows a schematic side elevation view of the 3D printer head for the 3D printer assembly of FIG. 2 in use;

FIG. 9 shows a schematic perspective view of a 3D printer head and a laser head for a 3D printer assembly according to another example embodiment;

FIG. 10 shows another schematic perspective view of the 3D printer head and the laser head of FIG. 9;

FIG. 11 shows a schematic bottom elevation view of the 3D printer head and the laser head of FIG. 9;

FIG. 12 shows a schematic perspective view of the 3D printer head of FIG. 9;

FIG. 13 shows a schematic front elevation view of the 3D printer head of FIG. 9;

FIG. 14 shows a schematic cross-sectional perspective view of the 3D printer head of FIG. 9;

FIG. 15 shows a schematic side exploded perspective view of the 3D printer head of FIG. 9;

FIG. 16 shows a schematic partially-transparent perspective view of the 3D printer head for the 3D printer assembly of FIG. 9 in use;

FIG. 17 shows a schematic partially-transparent side elevation view of the 3D printer head for the 3D printer assembly of FIG. 9 in use;

FIG. 18 shows a schematic partially-transparent side elevation view of the 3D printer head for the 3D printer assembly of FIG. 9 in use;

FIG. 19 shows a schematic partially-transparent side elevation view of the 3D printer head for the 3D printer assembly of FIG. 9 in use;

FIG. 20 shows a schematic partially-transparent side elevation view of the 3D printer head for the 3D printer assembly of FIG. 9 in use;

FIG. 21 shows a schematic flowchart of an example method of operating a 3D printer assembly according to yet another example embodiment; and

FIG. 22 shows a schematic flowchart of an example method of operating a 3D printer assembly according to still yet another example embodiment.

### DESCRIPTION OF EXAMPLE EMBODIMENTS

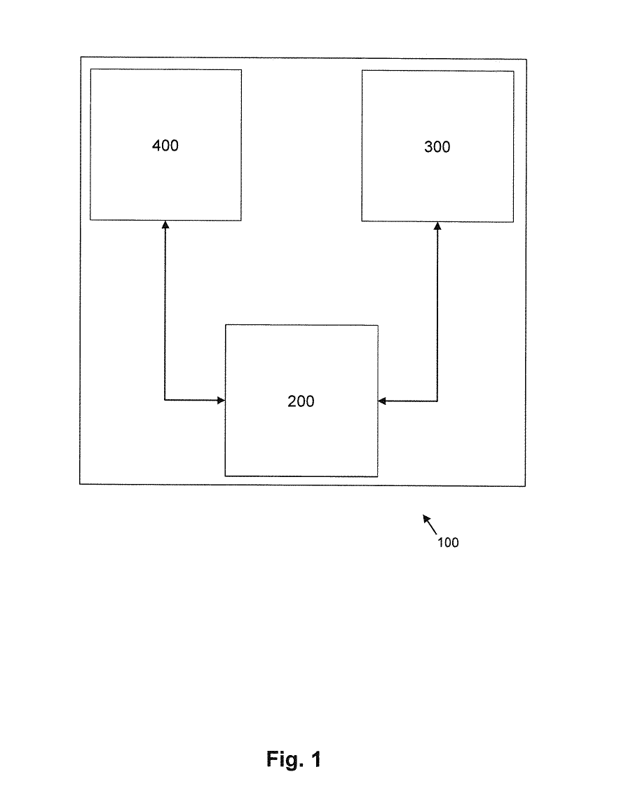

FIG. 1 shows a schematic view of a 3D printer assembly 100 according to an example embodiment. A laser head 400 and a 3D printer head 300 are coupled to a controller 200. For example, laser head 400 is communicatively and/or optically and/or mechanically coupled to controller 200 and 3D printer head 300 is communicatively coupled to controller 200, in which a communicative coupling may be uni-directional or bi-directional. Further, laser head 400 may be coupled to 3D printer head 300 (not shown). For example, laser head 400 may be communicatively and/or optically and/or mechanically coupled to 3D printer head 300, in which a communicative coupling may be uni-directional or bi-directional.

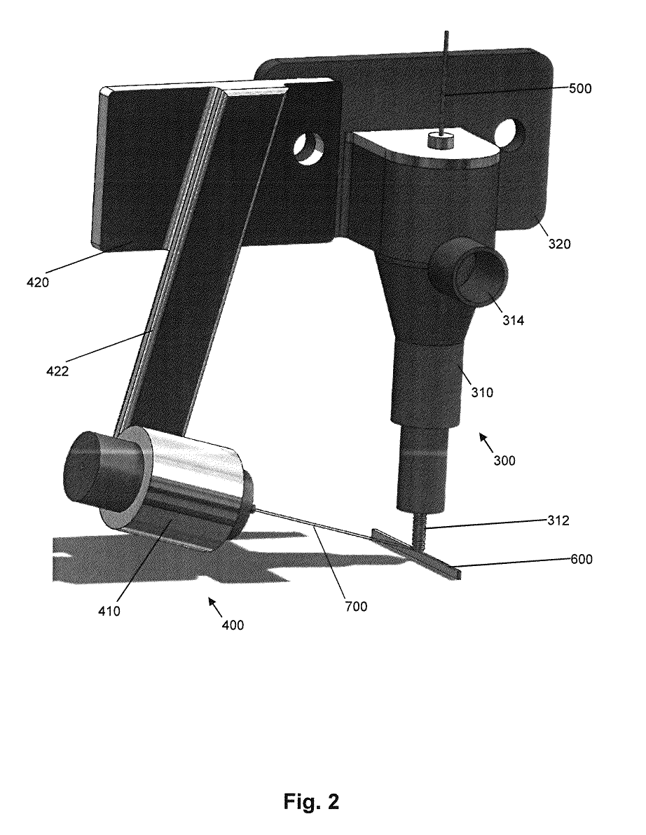

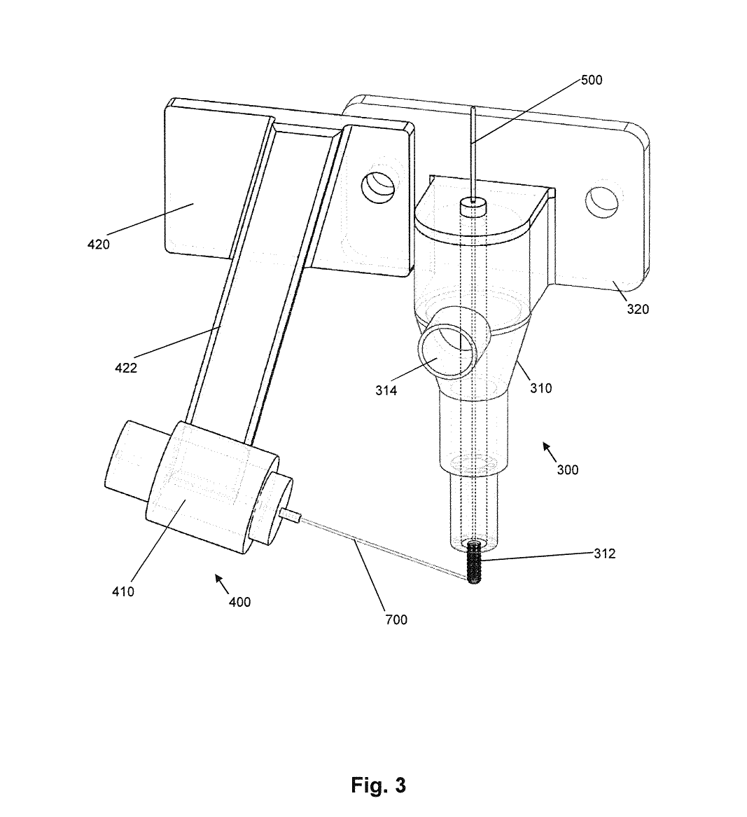

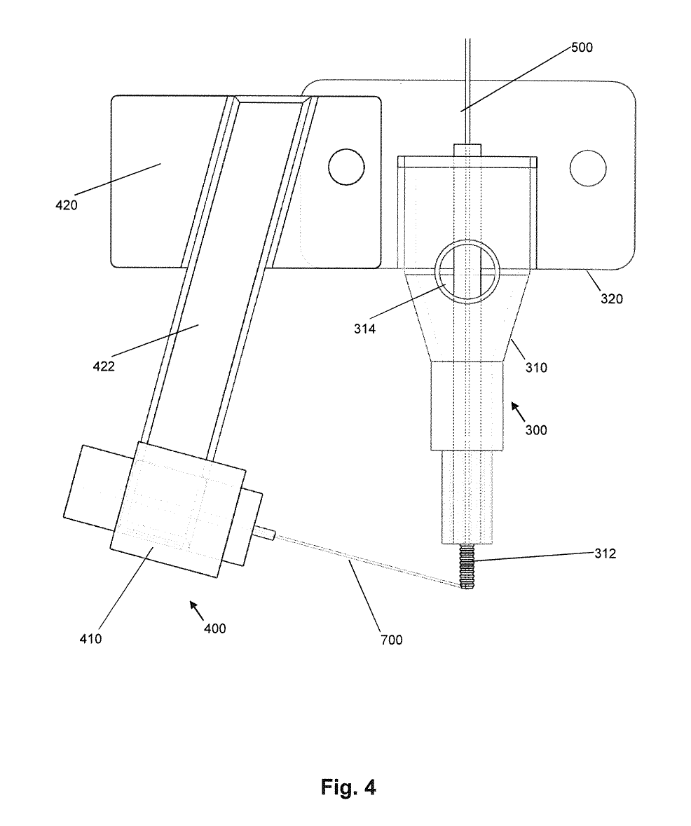

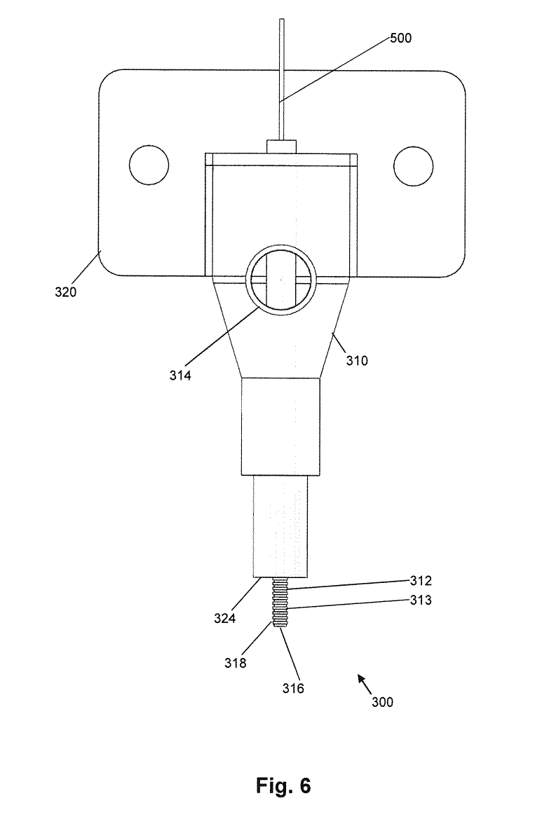

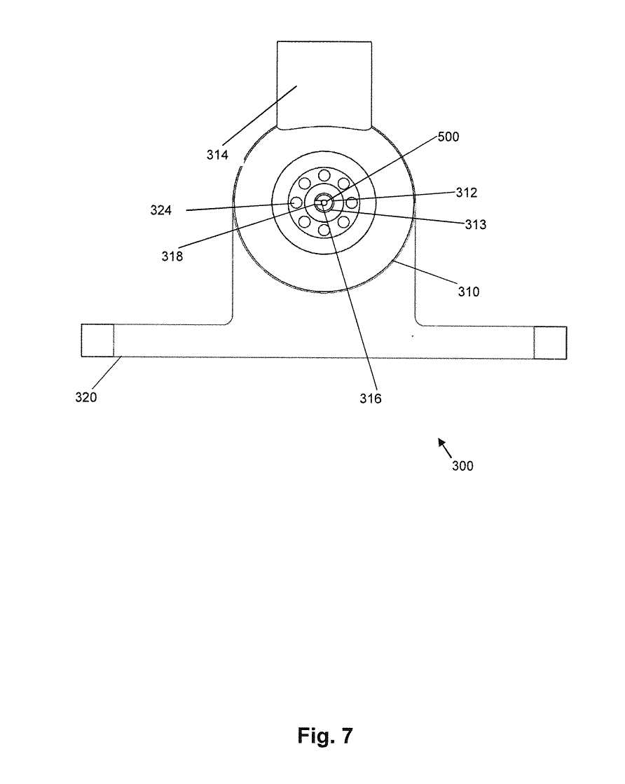

An example embodiment of a 3D printer assembly 100 is now described with reference to FIGS. 2-8. This example embodiment provides an open head for printing of a 3D component from a filler material.

FIGS. 2-4 show a schematic perspective view, a schematic, partially-transparent perspective view and a schematic front elevation view respectively of a 3D printer head 300 and a laser head 400 for a 3D printer assembly 100 (controller 200 not shown) according to an example embodiment.

The laser head 400 is coupled to a pulsed laser (not shown), for example, a pulsed Nd:YAG laser, a JK™ Lasers JK300 or JK450 laser. The laser head 400 is also coupled to the controller 200. The laser head 400 comprises a focussing head and may be arranged typically to adjust a laser spot size from 60 μm to 1.8 mm. The laser head 400 may comprise a coaxial gas delivery system. The laser head 400 may be sealed to IP54 for demanding environmental conditions. The laser head 400 comprises a laser head body 410 coupled to a repositionable coupling member 422 attached to mounting bracket 420. In this way, an angle and/or position of the laser head 400 may be predetermined and/or adjusted. The laser head 400 is configured to deliver one or more laser pulses 700 generated by the pulsed laser, in which, for a 1.75 mm diameter aluminium alloy wire filler material 500, the laser pulses 700 have a spot size of around 1 mm, a selectable pulse length in a range of around 5 ms to around 10 ms, a selectable pulse energy in a range of around 10 J to around 20 J, a selectable pulse frequency in a range of around 15 Hz (JK300) to around 22 Hz (JK450). It will be appreciated that these laser pulse parameters are exemplary only and may be modified according to, for example, a type of filler material and/or an angle of incidence.

The 3D printer head 300 comprises a 3D printer head body 310 coupled to a 3D printer head mounting bracket 320. In this way, an angle and/or position of the 3D printer head 300 may be predetermined and/or adjusted.

The 3D printer head 300 is arranged to receive a filler material 500 proximal an end of the 3D printer head body 310 and delivered by the 3D printer head 300 through a 3D printer tip 312 proximal an opposite end of the 3D printer head body 310. In this example embodiment, the filler material 500 comprises a 1.75 mm diameter 6XXX series aluminium alloy solid wire, supplied on a spool. For example and as shown in FIGS. 2-4, the filler material 500 may be received, for example from the spool of the filler material 500, by the 3D printer head 300 through an aperture arranged in an upper face of the 3D printer head body 310 and delivered through a 3D printer tip 312 arranged on a lower face of the 3D printer head body. In this way, the filler material 500 may be, for example, straightened by a conduit (not shown) and/or a roller assembly (not shown) in the 3D printer head body. Further, the filler material 500 to be received by the 3D printer head body 310 is thus relatively further from a substrate 600 than the 3D printer tip 312 and hence the 3D printer head 300 and/or 3D printer head assembly may be repositioned while maintaining appropriate receipt of the filler material 500 into the 3D printer head body 310 and/or the filler material to be received not interfering with the 3D printing. The 3D printer head 300 comprises a filler material feed assembly (not shown), arranged to receive the filler material 500 and deliver the filler material 500 through the 3D printer tip 312. For example, the filler material feed assembly may comprise a powered roller, arranged to feed the filler material through the 3D printer tip 312. The filler material feed assembly may be controlled by the controller 200 so as to control a rate and/or direction of feed.

The 3D printer tip 312 is arrangeable proximal to the substrate 600 and to deliver the filler material 500 towards the substrate 600, upon which the filler material 500 may be printed or deposited by the 3D printer assembly 100. Particularly, the 3D printer head 300 is arrangeable such that the filler material 500 is delivered at an angle of inclination with respect to a direction of travel in use. For example, the 3D printer tip 312 is arranged at a push angle in a range 10-15 degrees with respect to a vertical direction (i.e. 75-80 degrees with respect to the substrate 600) and the direction of travel. Alternatively, the 3D printer tip 312 may be arranged perpendicular to the substrate 600 or at a drag angle. In this way, for example, a porosity of deposited filler material may be controlled.

The 3D printer head 300 further comprises a shield gas inlet 314, connectable to a shield gas supply, and arranged to receive a flow of a shield gas from the shield gas supply. In this example embodiment, the shield gas (not shown) comprises 100% argon (e.g. Pureshield Argon) and is supplied at a flow rate of 7-21 L/min. The shield gas inlet 314 is in fluid communication with a shield gas outlet proximal the 3D printer tip 312, as described in detail below, thereby providing the shield gas towards the filler material 500 delivered by the 3D printer head.

As will be understood, the shield gas provides a suitable atmosphere for pulsed laser deposition of the filler material 500 by the 3D printer assembly 100 so as to minimise and/or control oxidation of deposited filler material and/or heated substrate. The shield gas may be provided continuously during the 3D printing of a 3D component to be printed or may be provided intermittently. Further, shield gas may be provided before deposition (for example, for purging) and/or after deposition (for example, for controlled cooling). In this example embodiment, the controller 200 is configured to control a MFC for the shield gas though other examples may be provided in which the flow of shield gas is controlled by other means, for example, manual control of a flow valve. In this example embodiment, while 100% argon is used, other gas mixes for example, Alushield Light, Alushield Universal, Alushield Heavy, may be used, according to the deposition conditions.

The laser head 400 and the 3D printer head 300 are relatively arrangeable and arranged whereby a laser pulse 700 delivered by the laser head 400 is focussed towards and incident proximal to an exposed end of the filler material 500 delivered through the 3D printer tip 312 proximal the substrate 600, as described in more detail below. In this example embodiment, the laser pulse 700 is focussed to a 1 mm spot size, at an angle of incidence of approximately 45 degrees, at a contact interface between the end of the filler material 500 and the substrate 600 so as to heat both the filler material 500 and the substrate, as described in more detail below.

The laser head 400 and/or the 3D printer head 300 are mounted on a moveable assembly (not shown), for example a robotic arm or a multi-axis manipulator, which may be controlled by the controller 200. Alternatively, the laser head 400 and/or the 3D printer head 300 may be separately mounted on two moveable assemblies (not shown), for example two robotic arms or two multi-axis manipulators or one robotic arm and one multi-axis manipulator, which may be controlled by the controller 200. In this way, a position of the laser head 400 and/or the 3D printer head 300 may be moved in use, such that the filler material 500 may be delivered by the 3D printer head 300 to a predetermined position. For example, the controller 200 may control the predetermined position to which the filler material 500 is delivered in use, according to an instruction received by the controller 200. Further, the controller 200 may control a plurality of predetermined positions to which the filler material 500 is delivered in use, for example, according to a drawing or design or model received by the controller 200 and to be printed by the 3D printer assembly 100. Still further, the controller 200 may control a speed and/or direction of movement of the laser head 400 and/or the 3D printer head 300, thereby controlling a rate and/or position of deposition of the filler material 500.

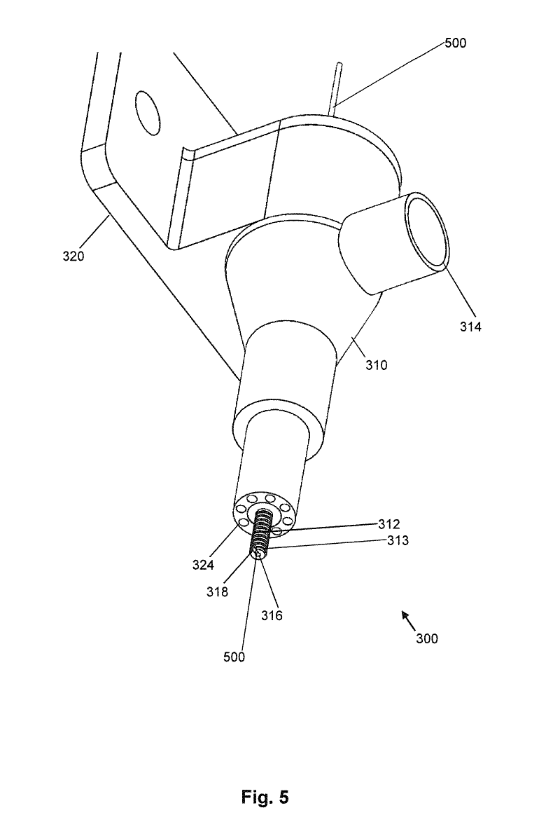

FIGS. 5-7 show a schematic perspective view, a schematic, partially-transparent front elevation view and a schematic bottom elevation view respectively of the 3D printer head 300 in more detail according to the example embodiment of FIGS. 2-4.

In more detail, in this example embodiment, the 3D printer head body 310 comprises a plurality of shield gas outlets 324 in fluid communication with the shield gas inlet 314. The shield gas outlets 324 are arranged proximal an outer surface of the 3D printer tip 312 and oriented so as to deliver the shield gas coaxially to the 3D printer tip 312. In this way, shield gas delivered by the shield gas outlets 324 tends to cool the 3D printer tip 312 as well as primarily providing a shield gas atmosphere for deposition of the filler material 500. While a plurality of shield gas outlets 324 are shown in the example embodiment, it is understood that this is for illustration only and other arrangements may be provided for providing the shield gas atmosphere, for example, by a different arrangement of the shield gas outlets 324 or by providing an shield gas enclosure for the 3D printer assembly 100.

In more detail, in this example embodiment, the 3D printer tip 312 comprises a machined Inconel 625 barrel, comprising a plurality of circumferential cooling fins 313 on the outer surface of the 3D printer tip 312 and arranged to cool the 3D printer tip 312, and an axial bore 316, through which the filler material 500 is delivered in use. The 3D printer tip 312 is arranged to be releasably coupleable to the 3D printer head body 310, such that the 3D printer tip 312 may be replaced as necessary. The 3D printer tip 312 further comprises a laser pulse aperture 318, through which a laser pulse delivered by the laser head 400 is delivered to the filler material 500 delivered through the 3D printer tip 312, as described in more detail below. In this example embodiment, the laser pulse aperture 318 comprises a passageway from the outer surface of the 3D printer tip 312 to the axial bore 316, proximal an end of the 3D printer tip 312 through which the filler material 500 is delivered in use.

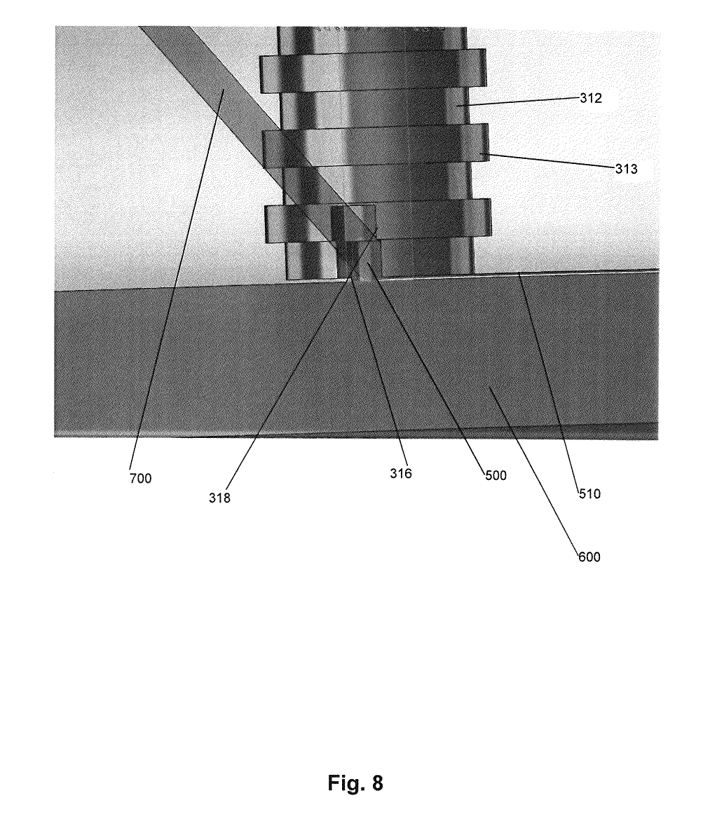

FIG. 8 shows a schematic perspective view of the 3D printer head 300 in more detail according to the example embodiment of FIGS. 2-7.

In more detail, the controller 200 controls the 3D printer head 300 to deliver shield gas through the shield gas outlets 324, as described previously. The controller 200 controls the 3D printer head 300 to move such that the 3D printer tip 312 is moved to a predetermined position and/or a predetermined angle and/or predetermined orientation, as described previously. The controller 200 also controls the laser head 400 to move such that the laser head 400 is targeted towards a predetermined position and/or a predetermined angle and/or predetermined orientation absolutely and/or relatively with respect to the 3D printer head 300 and/or substrate, as described previously. The controller 200 controls the 3D printer head 300 to feed the filler material 500 towards the substrate 600, as described previously, until an end of the filler material 500 becomes proximal to and/or contacts the substrate 600. The controller 200 controls the laser head 400 to deliver a laser pulse 700 towards the end of the filler material 500 proximal to and/or in contact with the substrate 600, through the laser pulse aperture 318 in the 3D printer tip 312. The controller 200 may control the laser head 400 to deliver the laser pulse 700 towards the substrate 600 proximal to and/or in contact with the end of the filler material 500, through the laser pulse aperture 318 in the 3D printer tip 312. The controller 200 may control the laser head 400 to deliver the laser pulse 700 towards the end of the filler material 500 proximal to and/or in contact with the substrate 600 and towards the substrate 600 proximal to and/or in contact with the end of the filler material 500, through the laser pulse aperture 318 in the 3D printer tip 312, for example, to a region of contact between the filler material 500 and the substrate 600. The controller 200 may control the laser head 400 to deliver the laser pulse 700 or a plurality of such laser pulses, so as to melt an amount of the filler material 500 (for example, the end of the filler material 500 in contact with the substrate 700). If the 3D component to be printed will comprise the substrate 600 (for example, where the substrate 600 comprises previously deposited filler material 500 and/or the substrate 600 comprises a previously part-finished component), the controller 200 may control the laser head 400 to deliver the laser pulse 700 or a plurality of such laser pulses, so as to melt an amount of the substrate 600 (for example, a volume of substrate 700 in contact with the filler material 500). The controller 200 controls the 3D printer head 300 to feed the filler material 500 towards the substrate 600, as described previously, thereby feeding the amount of the melted filler material 500 towards the substrate. An amount of the melted filler material 500 may solidify on the substrate 600, thereby depositing the filler material 500 on the substrate 600. If the 3D component to be printed will comprise the substrate 600 (for example, where the substrate 600 comprises previously deposited filler material 500 and/or the substrate 600 comprises a previously part-finished component), the amount of the melted filler material 500 may weld or fuse with the substrate 600, thereby depositing the filler material 500 on the substrate 600. By melting the amount of the substrate 600 upon which the deposited filler material is deposited, mixing of the substrate 600 and deposited filler material is enhanced, thereby improving an integrity (for example, a structural integrity, a microstructural integrity, a metallurgical property, a weld quality) of the deposited filler material and additionally, preventing oxidation and/or removing an oxide layer of the substrate 600 and/or removing micro-cracking that may be present in previously-deposited filler material and/or the substrate 600. In this example embodiment, an approximately 0.1 mm length of the filler material 500 is deposited for each laser pulse 700. The controller 200 may control the 3D printer assembly 100 to repeatedly deposit filler material 500 as described above including onto previously deposited filler material, for example, according to a design for a 3D component. In this way, the 3D component may be printed from the filler material 500 by the 3D printer assembly 100.

In another example embodiment, the controller 200 may control the 3D printer assembly 100 to continuously deposit filler material 500 by controlling the 3D printer head 300 to continuously feed the filler material 500 towards the substrate 600 and by controlling the laser head 400 to deliver a plurality of laser pulses 700, so as to continuously melt an amount of the filler material 500 and deposit the melted filler material 500 on the substrate 600.

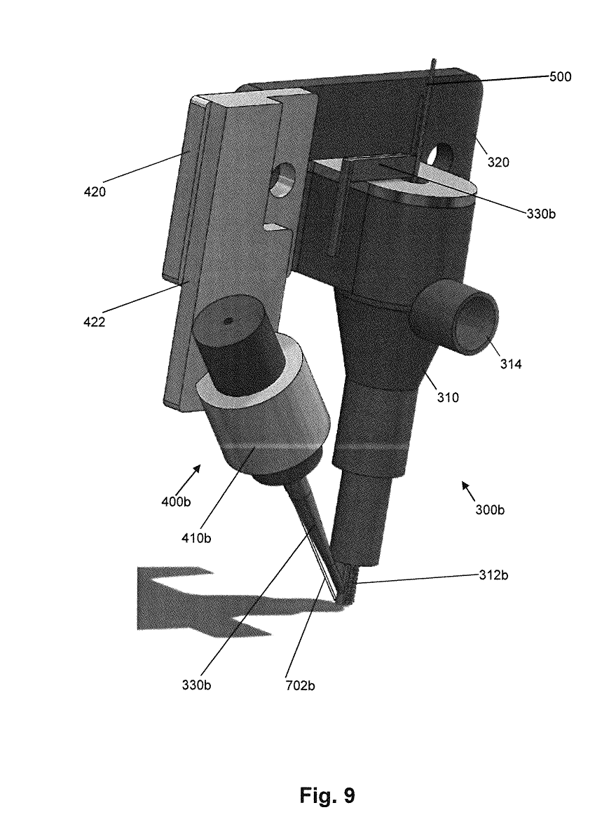

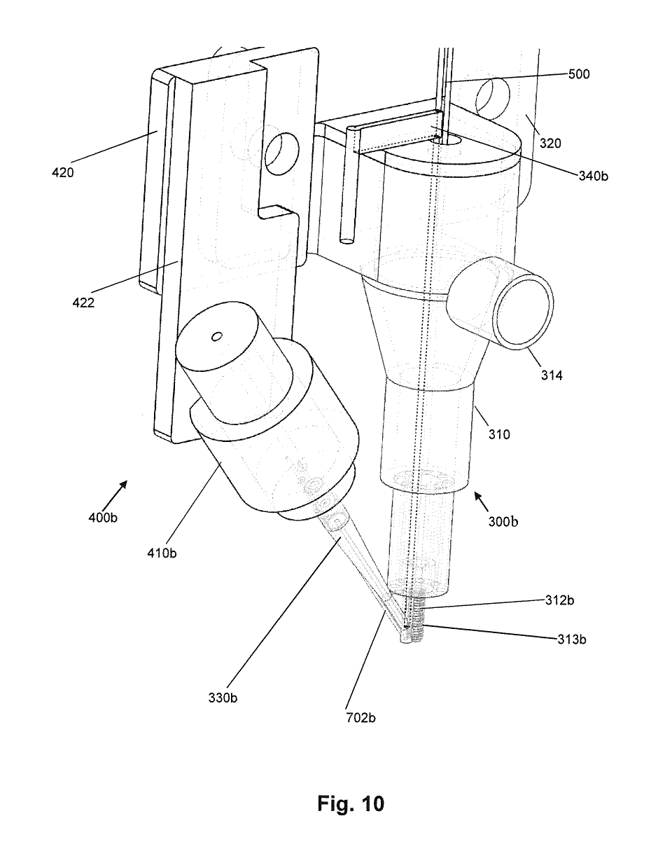

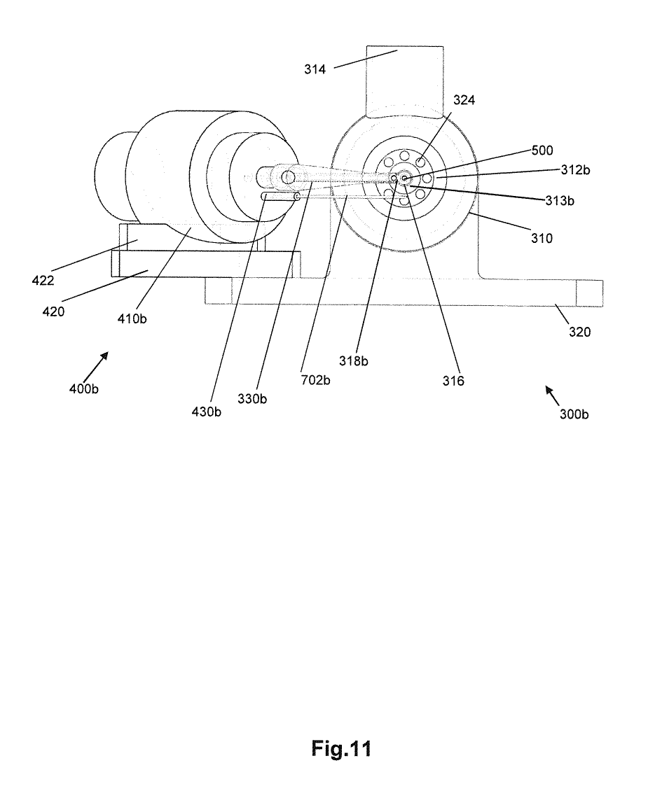

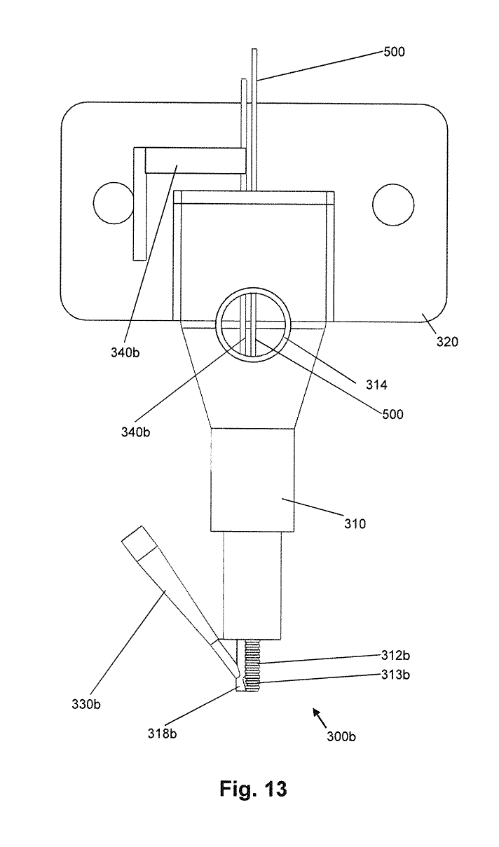

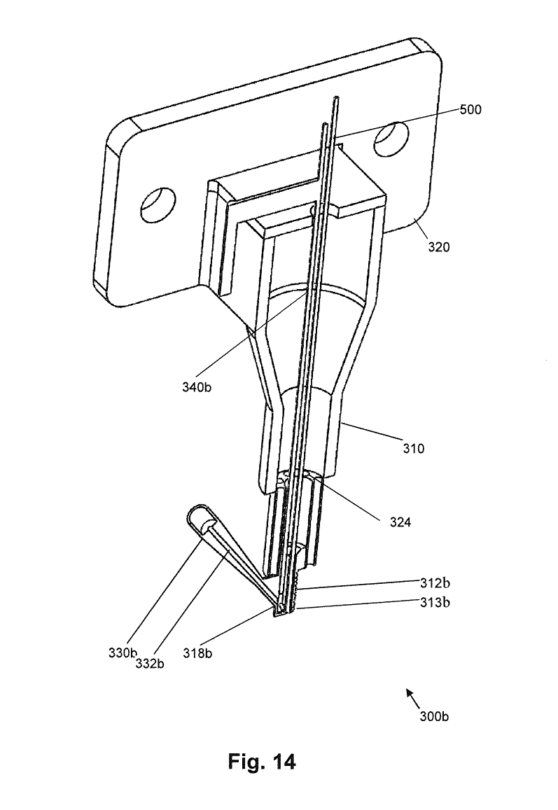

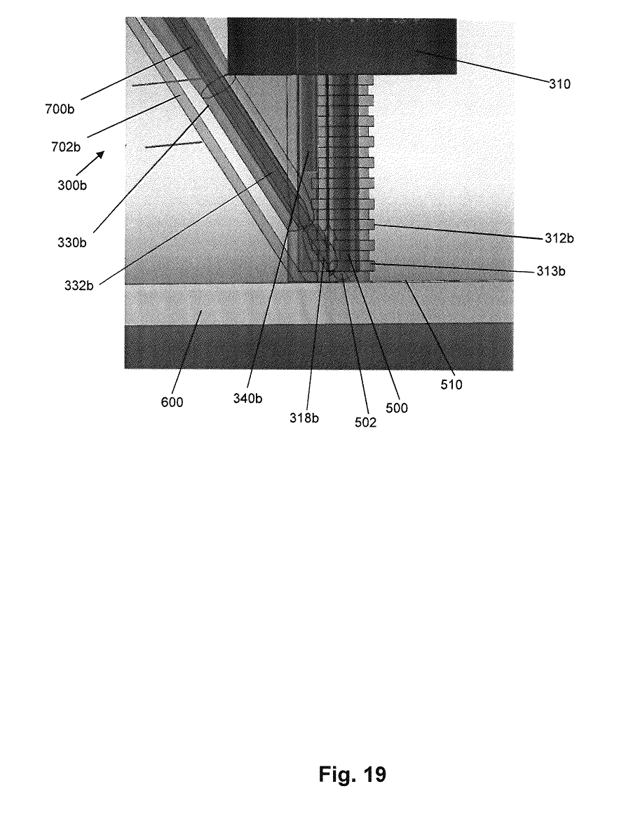

Another example embodiment of a 3D printer assembly 100b is now described with reference to FIGS. 9-19. This example embodiment provides a closed chamber for printing of a 3D component from a filler material. In FIGS. 9-19, like numerals with respect to FIGS. 2-8 reference like features and may not be further described, for conciseness.

FIGS. 9-11 show a schematic perspective view, a schematic, partially-transparent perspective view and a schematic bottom elevation view respectively of a 3D printer head 300b and a laser head 400b for a 3D printer assembly 100b (controller 200b not shown) according to an example embodiment.

The laser head 400b is coupled to the pulsed laser (not shown) and to the controller 200b and further arranged as described previously with reference to the laser head 400. The laser head 400b comprises a focussing head configured to deliver a laser pulse 700b, as described previously and additionally, a secondary laser pulse 702b targeted towards a position proximal to the target position of laser pulse 700b. In this example embodiment, the secondary laser pulse 702b is delivered by the laser head 400b through a secondary laser pulse guide 430b.

The 3D printer head 300b further comprises a laser pulse guide 330b, releasably coupleable to the laser head 400b, and through which the laser pulse 700b is delivered by the laser head 400b. The laser pulse guide 330b is coupled to a 3D printer tip 312b, as will be described in more detail below. The 3D printer head 300b further comprises a shutter assembly 340b, configured to isolate the laser pulse guide 330b from the 3D printer tip 312b.

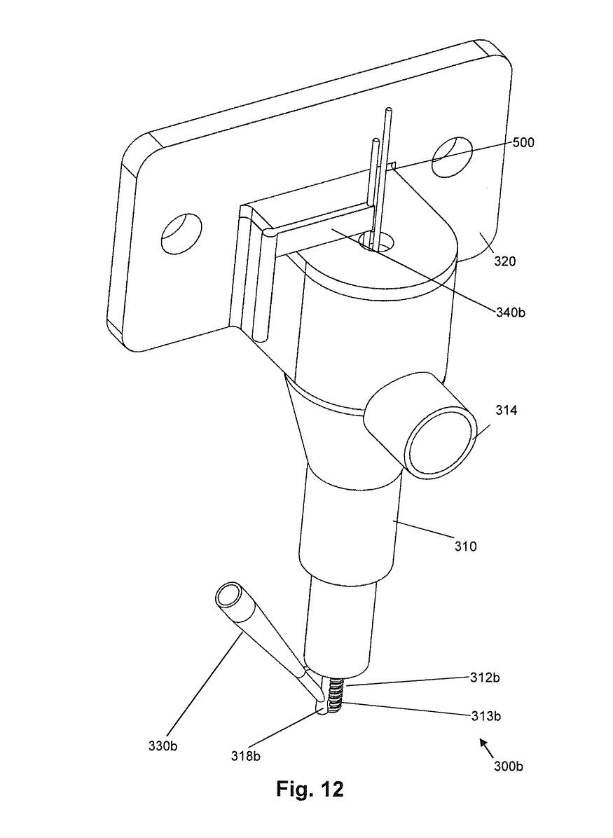

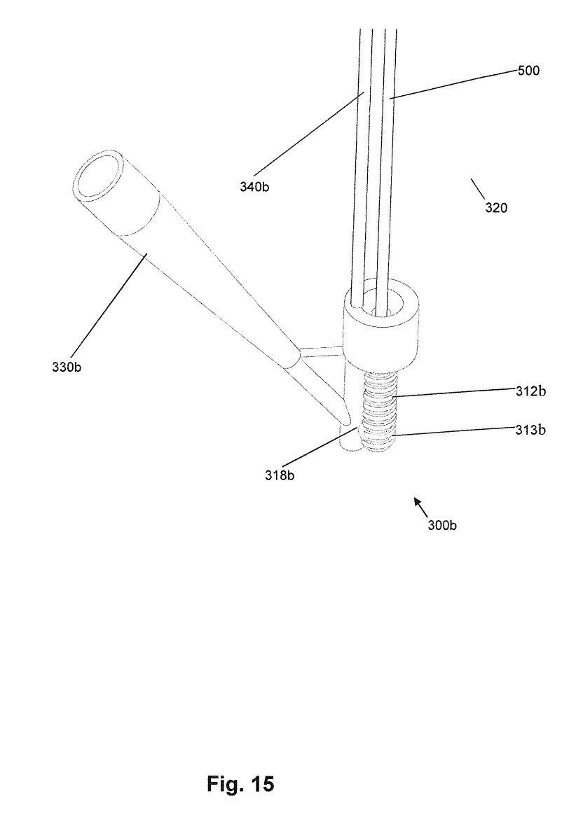

FIGS. 12-14 show a schematic perspective view, a schematic front elevation view and a schematic cross-sectional perspective view respectively of the 3D printer head 300b in more detail according to the example embodiment of FIGS. 9-11. FIG. 15 shows a schematic exploded perspective view of the 3D printer head 300b in more detail according to the example embodiment of FIGS. 12-14.

The laser pulse guide 330b comprises a laser passageway 332b through which the laser pulse 700b may be delivered in use. The laser passageway 332b is in optical and/or fluid communication with a laser pulse aperture 318b, formed through a wall of the 3D printer tip 312b to the axial bore 316 of the 3D printer tip 312b, proximal an end of the 3D printer tip 312b through which the filler material 500 is delivered in use. The shutter assembly 340b is received by a second off-axis passageway in the 3D printer tip 312b, parallel with the bore 316 of the 3D printer tip 312b, that intersects with the laser passageway 332b. The shutter assembly 340b is arrangeable to isolate the primary laser pulse guide 330b from the 3D printer tip 312b by restricting fluid communication through the laser passageway 332b, for example, by closing the laser passageway 332b. In this way, the 3D printer head 300b may provide a closed chamber for deposition while further isolating the laser head 400b from the 3D printer tip 312b.

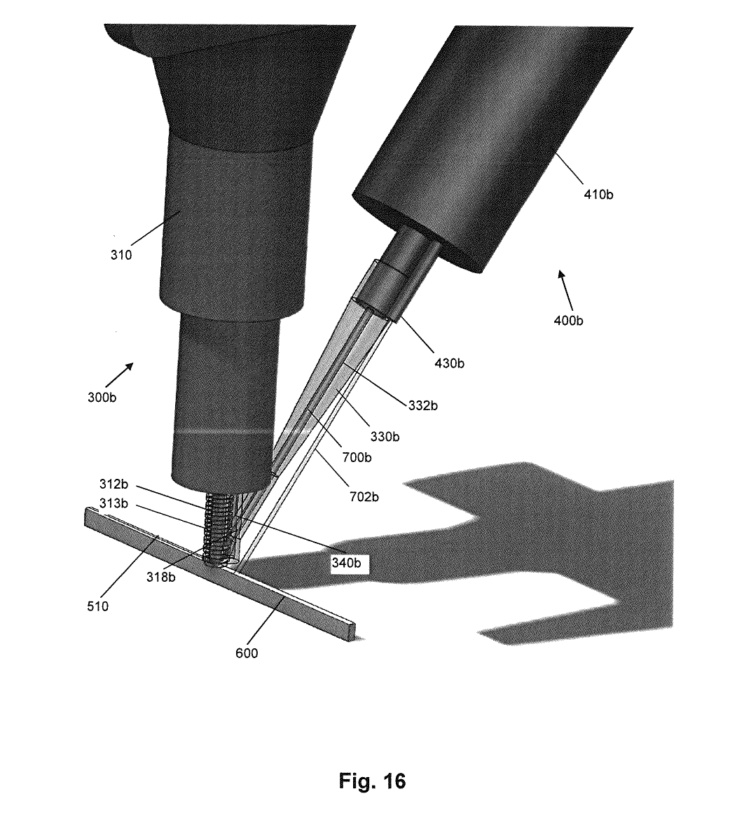

An operation of the 3D printer assembly 100b will now be described with reference to FIGS. 16-20. FIGS. 16-20 shows a schematic perspective view of the 3D printer assembly 100b and partially cut-through side elevation views respectively in more detail according to the example embodiment of FIGS. 9-15.

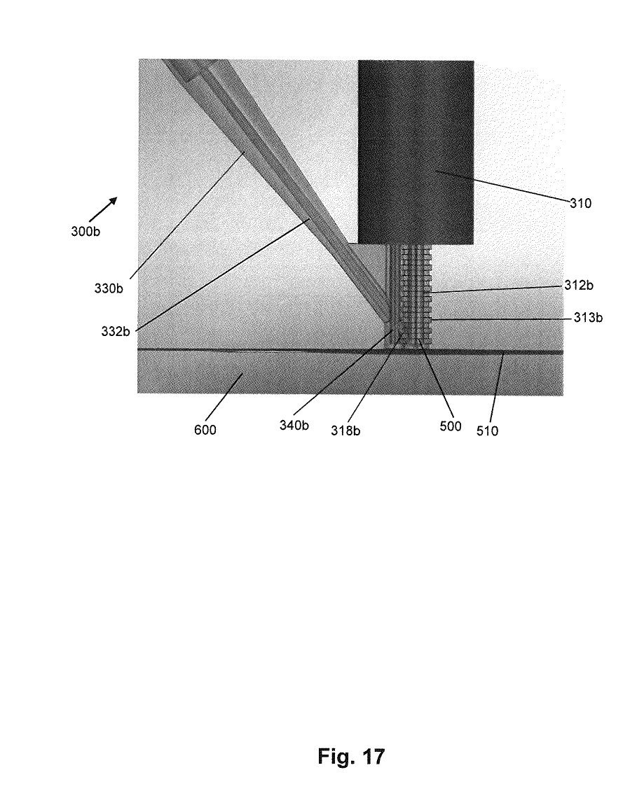

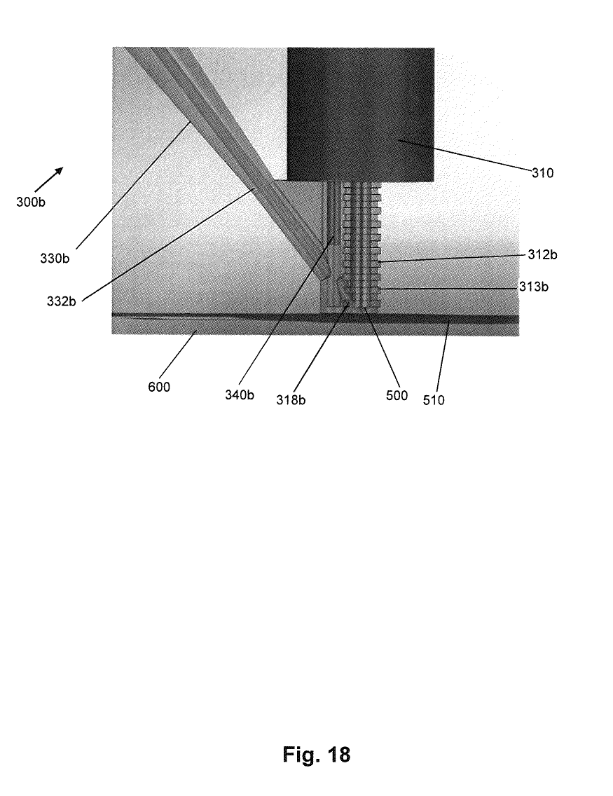

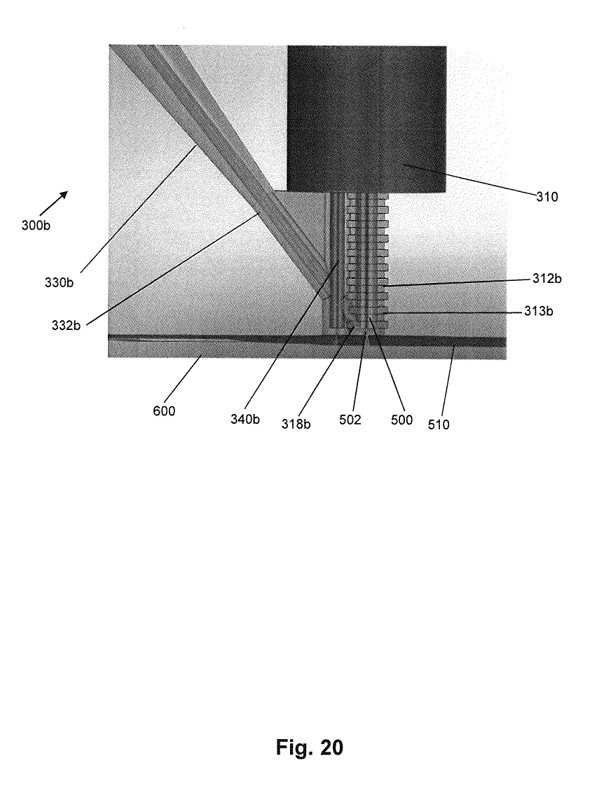

In more detail, the controller 200b controls the 3D printer head 300b to deliver shield gas through the shield gas outlets 324, as described previously. Additionally, the controller 200b controls the laser head 400b to deliver shield gas through the laser pulse guide 330b. The controller 200b controls the 3D printer head 300b to move such that the 3D printer tip 312b is moved to a predetermined position and/or a predetermined angle and/or predetermined orientation, as described previously. The controller 200b also controls the laser head 400b to move such that the laser head 400b is targeted towards a predetermined position and/or a predetermined angle and/or predetermined orientation absolutely and/or relatively with respect to the 3D printer head 300b and/or substrate, as described previously. The controller 200b controls the 3D printer head 300b to feed the filler material 500 towards the substrate 600, as described previously, until an end of the filler material 500 becomes proximal to and/or contacts the substrate 600, as shown in FIG. 17. The controller 200b controls the 3D printer head 300b to actuate the shutter assembly 340b to provide fluid and optical communication through the primary laser pulse guide 330b to the 3D printer tip 312b by, for example, opening the laser passageway 332b by retracting the shutter assembly 340b, as shown in FIG. 18. Shield gas delivered by the laser head 400b tends to flow towards the 3D printer tip 312b, thereby isolating the laser head 400b from, for example, filler material vapour and/or sputter i.e. gaseous and/or molten and/or solid filler material 500. The controller 200b controls the laser head 400b to deliver the secondary laser pulse 702b towards the substrate 600 proximal to and/or in contact with the end of the filler material 500, through the secondary laser pulse guide 430b, for example, to a region of contact between the filler material 500 and the substrate 600. The controller 200b controls the laser head 400b to deliver a laser pulse 700b towards the end of the filler material 500 proximal to and/or in contact with the substrate 600, through the primary laser pulse guide 330b and hence through the laser pulse aperture 318b in the 3D printer tip 312b. The controller 200 may control the laser head 400b to deliver the laser pulse 700b or the laser pulse 702b or a plurality of such laser pulses, so as to melt an amount of the filler material 500 (for example, the end of the filler material 500 in contact with the substrate 600) and/or an amount of the substrate 600 (for example, a volume of substrate 600 in contact with and/or proximal to the filler material 500). In this example embodiment, the laser head 400b is configured to deliver two secondary laser pulses 702b for each laser pulse 700b i.e. a 2:1 repeat sequence, though other examples may be provided with different repeat sequences for example 1:1, 1:2, 5:1, 1:5, 10:1, 1:10. The controller 200b controls the 3D printer head 300 to feed the filler material 500 towards the substrate 600, as described previously, thereby feeding the amount of the melted filler material 502 towards the substrate. An amount of the melted filler material 502 may solidify on the substrate 600, thereby depositing the filler material 500 on the substrate 600. If the 3D component to be printed will comprise the substrate 600 (for example, where the substrate 600 comprises previously deposited filler material 510 and/or the substrate 600 comprises a previously part-finished component), the amount of the melted filler material 502 may weld or fuse with the substrate 600, thereby depositing the filler material 500 on the substrate 600. By melting the amount of the substrate 600 upon which the deposited filler material 510 is deposited, mixing of the substrate 600 and melted filler material 502 is enhanced, thereby improving an integrity (for example, a structural integrity, a microstructural integrity, a metallurgical property, a weld quality) of the deposited filler material and additionally, preventing oxidation and/or removing an oxide layer of the substrate 600 and/or removing micro-cracking that may be present in previously-deposited filler material and/or the substrate 600. In this example embodiment, an approximately 0.1 mm length of the filler material 500 is deposited for each laser pulse 700. The controller 200b controls the 3D printer head 300b to actuate the shutter assembly 340b to restrict fluid and/or optical communication through the primary laser pulse guide 330b to the 3D printer tip 312b by, for example, closing the laser passageway 332b by returning the shutter assembly 340b, as shown in FIG. 20. Returning the shutter assembly 340b further tends to clean sputter from contacted surfaces. The controller 200b may control the 3D printer assembly 100b to repeatedly deposit the deposited filler material 510 as described above including onto previously deposited filler material, for example, according to a design for a 3D component. In this way, the 3D component may be printed from the filler material 500 by the 3D printer assembly 100b.

As set out above, the example embodiment described with reference to FIGS. 2-8 provides an open head for relatively higher deposition rates compared with the example embodiment described with reference to FIGS. 9-19, which provides a closed chamber for an enhanced control of filler material deposition conditions and hence 3D printing at a finer resolution though potentially at a relatively lower deposition rate.

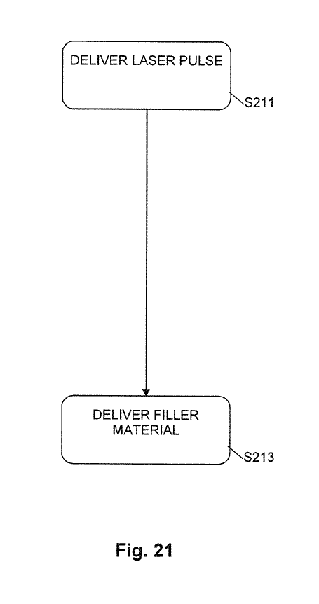

FIG. 21 is a schematic flowchart of an example method of operating a 3D printer assembly according to yet another example embodiment. In this case, as described in more detail above, the method includes step S211 of delivering a laser pulse to a filler material. Step S213 includes delivering the filler material (i.e. molten filler material) to, for example, a substrate. The step S211 may further include any of the steps discussed herein. In particular, the step S211 may include any of the steps discussed herein in relation to delivering the laser pulse. The step S213 may further include any of the steps discussed herein. In particular, the step S213 may include any of the steps discussed herein in relation to delivering the filler material.

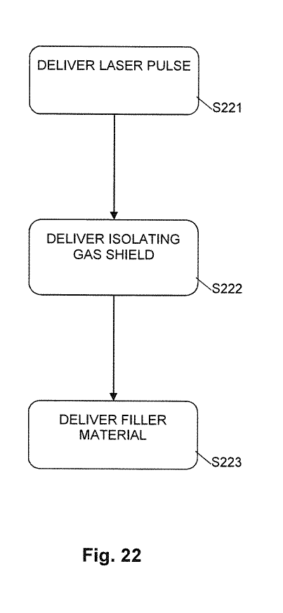

FIG. 22 is a schematic flowchart of an example method of operating a 3D printer assembly according to yet another example embodiment. In this case, as described in more detail above, the method includes step S221 of delivering a laser pulse to a filler material. Step S222 includes delivering an isolating gas shield to, for example, isolate a laser head of the 3D printer assembly from gaseous and/or molten and/or solid filler material. Step S223 includes delivering the filler material (i.e. molten filler material) to, for example, a substrate. The step S221 may further include any of the steps discussed herein. In particular, the step S221 may include any of the steps discussed herein in relation to delivering the laser pulse. The step S222 may further include any of the steps discussed herein. In particular, the step S222 may include any of the steps discussed herein in relation to isolating the laser head of the 3D printer assembly from gaseous and/or molten and/or solid filler material and/or the 3D printer head of the 3D printer assembly. The step S223 may further include any of the steps discussed herein. In particular, the step S223 may include any of the steps discussed herein in relation to delivering the filler material.

Although a few preferred embodiments have been shown and described, it will be appreciated by those skilled in the art that various changes and modifications might be made without departing from the scope of the invention, as defined in any appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A 3 dimensional, 3D, printer assembly for in use printing a 3D component from a filler material, the 3D printer assembly comprising:
a 3D printer head arranged to in use deliver the filler material;
a laser head for a laser arranged to in use deliver a laser pulse to the filler material to melt an amount of the filler material; and
a controller arranged to control the printer head and the laser head to in use print the 3D component from the melted filler material;
wherein the 3D printer head comprises a 3D printer tip, wherein the 3D printer tip comprises a passageway through which the filler material is delivered in use by the 3D printer head and wherein the 3D printer tip comprises a laser pulse aperture through which the laser pulse is delivered in use to the filler material;
wherein the laser head comprises a laser pulse guide through which the laser pulse is delivered in use by the laser head;
wherein the laser pulse guide is coupled to the 3D printer tip; and
wherein the laser head comprises a gas outlet in fluid communication with the laser pulse guide, wherein the gas outlet is arranged to deliver a gas whereby in use the laser pulse guide comprises a gas arranged to isolate the laser head from the 3D printer head.

2. The 3D printer assembly according to claim 1, wherein the 3D printer head or the laser head is arranged to be repositioned in use.

3. The 3D printer assembly according to claim 1, wherein the filler material comprises an aluminium alloy.

4. The 3D printer assembly according to claim 1, wherein the filler material comprises a wire.

5. The 3D printer assembly according to claim 1, wherein the controller is arranged to in use modify one selected from a group comprising: a length, an energy and a frequency, of the laser pulse.

6. The 3D printer assembly according to claim 1, wherein the laser head is arranged to in use deliver a second laser pulse to the 3D component.

7. The 3D printer assembly according to claim 1, wherein the 3D printer assembly is arranged to in use deliver a temporary substrate material to in use print a temporary substrate on which the 3D component is printed in use by the 3D printer assembly.

8. The 3D printer assembly according to claim 1, wherein the 3D printer head comprises a second gas outlet arranged to in use deliver a second gas proximal the filler material delivered in use by the 3D printer head.

9. The 3D printer assembly according to claim 1, wherein the 3D printer assembly comprises a laser shutter arrangeable to in use isolate the laser head from the 3D printer head.

10. The 3D printer assembly according to claim 1, wherein the 3D printer assembly comprises a chamber arranged to enclose the 3D printer head and the laser head, wherein the chamber is arranged to comprise a gas.

11. A method of printing a 3 dimensional, 3D, component from a filler material using a 3D printer assembly according to claim 1, wherein the method comprises:
delivering the laser pulse to the filler material;
delivering the filler material; and
delivering a gas to isolate the laser head from the 3D printer head.

12. The method of printing according to claim 11, wherein the method of printing comprises delivering a second laser pulse to the 3D component.

13. The method of printing according to claim 11, wherein the method of printing comprises repositioning the 3D printer head or the laser head.

14. The method of printing according to claim 11, wherein the method of printing comprises modify one selected from a group comprising: a length, an energy and a frequency, of the laser pulse.

15. The method of printing according to claim 11, wherein the method of printing comprises delivering a temporary substrate material to print a temporary substrate on which the 3D component is printed by the 3D printer assembly.

16. The method of printing according to claim 11, wherein the method of printing comprises deliver a second gas proximal the filler material delivered by the 3D printer head.

17. The method of printing according to claim 11, wherein the 3D printer assembly comprises a laser shutter arrangeable to in use isolate the laser head from the 3D printer head and the method of printing comprises arranging the laser shutter to isolate the laser head from the 3D printer head.
